(19) United States
(12) Patent Application Publication
(10) Pub. No.: US 2025/0203390 A1
(43) Pub. Date: Jun. 19, 2025

(54) BEAMWIDTH AND RADIATED POWER CONTROL OF COVERAGE ENHANCING DEVICES

(71) Applicant: Sony Group Corporation, Tokyo (JP)

(72) Inventors: Erik BENGTSSON, Eslöv (SE); Fredrik RUSEK, Eslöv (SE); Kun ZHAO, Malmö (SE); Chaitanya TUMULA, Åkarp (SE)

(21) Appl. No.: 18/847,239

(22) PCT Filed: Mar. 21, 2023
(86) PCT No.: PCT/EP2023/057201

§ 371 Date: Sep. 14, 2024

(30) Foreign Application Priority Data
Mar. 30, 2022 (SE) 2250394-0

(51) Int. Cl. H04W 16/26; H04W 8/22; H04W 16/28

(52) U.S. Cl. CPC H04W 16/26; H04W 8/22; H04W 16/28

(57) ABSTRACT

A method of operating a coverage enhancing device (CED) is proposed, wherein the CED provides reconfigurable filters for incident signals received along one or more input spatial directions on a radio channel and transmitted as outgoing signals into one or more output spatial directions, the method comprising: applying a first filter of the reconfigurable filters to receive an incident signal along one or more spatial directions on a radio channel and transmitting the incident signal as an outgoing signal into an output spatial direction, obtaining a message related to a beamwidth to be used for transmitting the incident signal as the outgoing signal into the output spatial direction, applying a second filter of the reconfigurable filters to receive an incident signal along the one or more spatial directions on the radio channel and transmit the incident signal as the outgoing signal into the output spatial direction using the beamwidth based on the message related to the beamwidth. Further, a CED, a method of operating an operator node and an operator node are described.

### TECHNICAL FIELD

Various examples generally relate to communicating between communication nodes using coverage enhancing devices.

### BACKGROUND

In order to increase a coverage area for wireless communication, it is envisioned to use coverage enhancing devices (CEDs), particularly reconfigurable relaying devices (RRD), more particularly, reconfigurable reflective devices. Reconfigurable reflective devices are sometimes also referred to as reflecting large intelligent surfaces (LISs). Huang, C., Zappone, A., Alexandropoulos, G. C., Debbah, M., & Yuen, C.. Large intelligent surfaces for energy efficiency in wireless communication available at arXiv: 1810.06934v1

An RRD can be implemented by an array of antennas that can reflect incident electromagnetic waves/signals. The array of antennas can be semi-passive. Semi-passive can correspond to a scenario in which the antennas can impose a variable phase shift and typically provide no signal amplification. An input spatial direction from which incident signals on a radio channel are accepted and an output spatial direction into which the incident signals are transmitted, in particular reflected, can be reconfigured by changing a phase relationship between the antennas. Radio channel may refer to a radio channel specified by the 3GPP standard. In particular, the radio channel may refer to a physical radio channel. The radio channel may offer several time/frequency-resources for communication between different communication nodes of a communication system.

An access node (AN) may transmit signals to a wireless communication device (UE) via a CED. The CED may receive the incident signals from an input spatial direction and emit the incident signals in an output spatial direction to the UE. The AN may transmit the signals using a beam directed to the CED. In some scenarios, several CEDs may be used in parallel to transmit the signals from the AN to the UE.

In addition or alternatively to reconfiguring an input spatial direction of the CED from which incident signals on a radio channel are accepted and an output spatial direction into which the incidents signals are transmitted, reconfiguring may involve changing a beamwidth to be used for transmitting the incident signal as outgoing signal into the output spatial direction and/or changing a beamwidth to be used for accepting the incident signals.

Wider beamwidths may be advantageous in high mobility cases, i.e. in cases where the UE changes its position comparably fast. Narrower beamwidths may be less prone to interference problems, in particular interference problems due to multiple reflections.

Moreover, different beamwidths may be associated with different equivalent isotropically radiated power (EIRP) levels of the transmitted outgoing signal. A narrower beamwidth with the same transmitted power as a wider beam will lead to a higher EIRP level. There may be regulatory limitations concerning the allowed EIRP level.

### SUMMARY

Accordingly, there may be a need for an optimized beamwidth and radiated power control of coverage enhancing devices. Said need is addressed with the subject-matter of the independent claims. Advantageous embodiments are described in the dependent claims.

According to a first aspect, a method of operating a CED is provided, wherein the CED provides reconfigurable filters for incident signals received along one or more input spatial directions on a radio channel and transmitted as outgoing signals into one or more output spatial directions, the method comprising: applying a first filter of the reconfigurable filters to receive an incident signal along one or more spatial directions on a radio channel and transmitting the incident signal as an outgoing signal into an output spatial direction, obtaining a message related to a beamwidth to be used for transmitting the incident signal as the outgoing signal into the output spatial direction, applying a second filter of the reconfigurable filters to receive an incident signal along the one or more spatial directions on the radio channel and transmit the incident signal as the outgoing signal into the output spatial direction using the beamwidth based on the message related to the beamwidth.

According to a second aspect, a method of operating an operator node (ON) is provided, wherein the operator node is configured for controlling a coverage enhancing device, CED, wherein the CED provides reconfigurable filters for incident signals received along one or more input spatial directions on a radio channel and transmitted as outgoing signals into one or more output spatial directions, the method comprising: providing, to the CED, a message related to a beamwidth to be used for transmitting an incident signal as outgoing signal into an output spatial direction of the one or more output spatial directions.

According to a third aspect, a CED is provided, wherein the CED provides reconfigurable filters for incident signals received along one or more input spatial directions on a radio channel and transmitted as outgoing signals into one or more output spatial directions, the coverage enhancing device comprising control circuitry configured for performing an aforementioned method.

According to a fourth aspect, an operator node is provided, the operator node comprising control circuitry for controlling a CED, wherein the CED provides reconfigurable filters for incident signals received along one or more input spatial directions on a radio channel and transmitted as outgoing signals into one or more output spatial directions, wherein the control circuitry is configured for performing an aforementioned method.

### BRIEF DESCRIPTION OF THE DRAWINGS

FIG. 1 schematically illustrates a communication system according to various examples.

FIG. 2 schematically illustrates details of the communication system according to the example of FIG. 1.

FIG. 3 schematically illustrates multiple downlink transmit beams used at a transmitter node of the communication system and further schematically illustrates a CED towards which one of the multiple transmit beams is directed according to various examples.

FIG. 4 schematically illustrates details with respect to a CED.

FIG. 5 schematically illustrates a scenario benefitting from a CED.

FIG. 6 illustrates a flow chart showing a method of operating a CED,

FIG. 7 illustrates a method of operating an operator node.

FIG. 8 is a signaling diagram illustrating a communication between a CED and an ON.

FIG. 9 is a signaling diagram illustrating a communication between a CED and an ON.

### DETAILED DESCRIPTION

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, examples of the disclosure will be described in detail with reference to the accompanying drawings. It is to be understood that the following description of examples is not to be taken in a limiting sense. The scope of the disclosure is not intended to be limited by the examples described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Techniques are described that facilitate wireless communication between nodes. A wireless communication system includes a transmitter node and one or more receiver nodes. In some examples, the wireless communication system can be implemented by a wireless communication network, e.g., a radio-access network (RAN) of a Third Generation Partnership Project (3GPP)—specified cellular network (NW). In such case, the transmitter node can be implemented by an access node (AN), in particular, a base station (BS), of the RAN, and the one or more receiver nodes can be implemented by terminals (also referred to as user equipment, UE). It would also be possible that the transmitter node is implemented by a UE and the one or more receiver nodes are implemented by an AN and/or further UEs. Hereinafter, for the sake of simplicity, various examples will be described with respect to an example implementation of the transmitter node by one or more ANs and the one or more receiver node by UEs—i.e., to downlink (DL) communication; but the respective techniques can be applied to other scenarios, e.g., uplink (UL) communication and/or sidelink communication.

### Communication via CEDs

According to various examples, the transmitter node can communicate with at least one of the receiver nodes via one or more CEDs.

The CEDs may include an antenna array. The CEDs may include a meta-material surface. In examples, the CEDs may include a reflective antenna array (RAA).

There are many schools-of-thought for how CEDs should be integrated into 3GPP-standardized RANs.

In an exemplary case, the NW operator has deployed the CEDs and is, therefore, in full control of the CEDs' operations. The UEs, on the other hand, may not be aware of the presence of any CED, at least initially, i.e., it is transparent to a UE whether it communicates directly with the AN or via the CEDs. The CEDs essentially function as a coverage-extender of the AN. The AN may have established control links with the CEDs.

According to another exemplary case, it might be a private user or some public entity that deploys the CEDs. Further, it may be that the UE, in this case, controls the CEDs' operations. The AN, on the other hand, may not be aware of the presence of any CED and, moreover, may not have control over it/them whatsoever. The UE may gain awareness of the presence of a CED by means of some short-range radio technology, such as Bluetooth, wherein Bluetooth may refer to a standard according to IEEE 802.15, or WiFi, wherein WiFi may refer to a standard according to IEEE 802.11, by virtue of which it may establish the control link with the CED. It is also possible that the UE gains awareness of the presence of a CED using UWD (Ultra wideband) communication. Using UWB may offer better time resolution due to the wider bandwidth compared to other radio technologies.

The two exemplary cases described above are summarized in TAB. 1 below.

TABLE 1
Scenarios for CED integration into cellular NW

| Scenario | Description | Explanation |
|---|---|---|
| A | AN-CED | AN controls the CED and/or can obtain |
| | control link | information from the CED. A control link is |
| | | established between the AN and the CED. |
| B | UE-CED | UE controls the CED and/or can obtain |
| | control link | information from the CED. A control link is |
| | | established between the UE and the CED. |

Hereinafter, techniques will be described which facilitate communication between a transmitter node—e.g., an AN—and one or more receiver nodes—e.g., one or more UEs-using a CED.

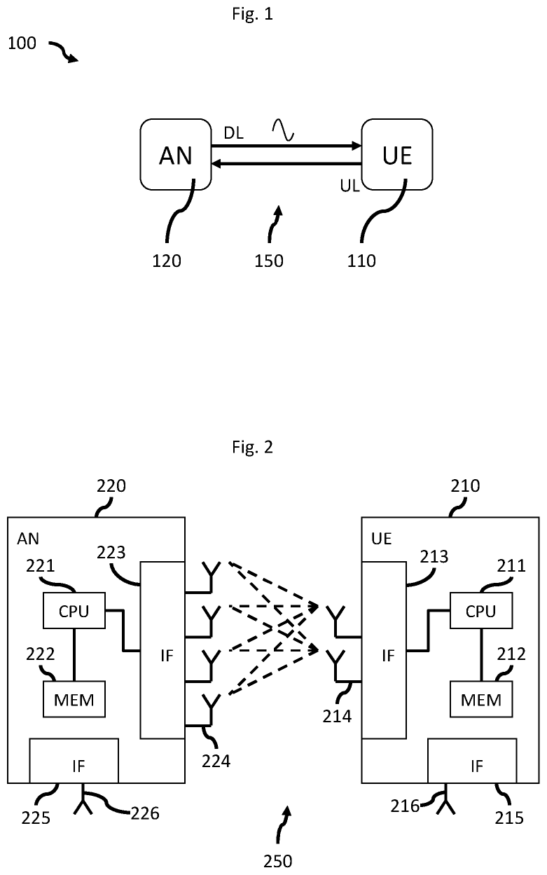

FIG. 1 schematically illustrates a communication system 100. The communication system 100 includes two nodes 110, 120 that are configured to communicate with each other via a radio channel 150. In the example of FIG. 1, the node 120 is implemented by an access node (AN) and the node 110 is implemented by a UE. The AN 120 can be part of a cellular NW (not shown in FIG. 1).

As a general rule, the techniques described herein could be used for various types of communication systems, e.g., also for peer-to-peer communication, etc. For the sake of simplicity, however, hereinafter, various techniques will be described in the context of a communication system that is implemented by an AN 120 of a cellular NW and a UE 110.

As illustrated in FIG. 1, there can be DL communication, as well as UL communication. Some examples described herein focus on the DL communication, but similar techniques may be applied to UL communication and/or sidelink communication. FIG. 2 illustrates details with respect to the AN 220. The AN 220 includes control circuitry that is implemented by a processor 221 and a non-volatile memory 222. The processor 221 can load program code that is stored in the memory 222. The processor 221 can then execute the program code. Executing the program code causes the processor to perform techniques as described herein.

Moreover, FIG. 2 illustrates details with respect to the UE 210. The UE 210 includes control circuitry that is implemented by a processor 211 and a non-volatile memory 212. The processor 211 can load program code that is stored in the memory 212. The processor can execute the program code. Executing the program code causes the processor to perform techniques as described herein.

Further, FIG. 2 illustrates details with respect to communication between the AN 220 and the UE 210 on the radio channel 250. The AN 220 includes an interface 223 that can access and control multiple antennas 224. Likewise, the UE 210 includes an interface 213 that can access and control multiple antennas 214.

The UE 210 comprises a further interface 215 that can access and control at least one antenna 216 to transmit or receive a signal on an auxiliary radio channel different from the radio channel 250. Likewise, the AN 220 may comprise an additional interface 225 that can access and control at least one antenna 226 to transmit or receive a signal on the or a further auxiliary radio channel different from the radio channel. In general, the interface 225 may also be a wired interface. It may also be possible that the interface 225 is a wired or wireless optical interface. If wireless, the auxiliary radio channel may use in-band signaling or out-of-band signaling. The radio channel and the auxiliary radio channel may be offset in frequency. The auxiliary radio channel may be at least one of a Bluetooth radio channel, a WiFi channel, or an ultra-wideband radio channel. Methods for determining an angle of arrival may be provided by a communication protocol associated with the auxiliary radio channel. For example, methods for determining an angle of arrival may be provided by a Bluetooth radio channel.

While the scenario of FIG. 2 illustrates the antennas 224, 226 being coupled to the AN 220, as a general rule, it would be possible to employ transmit-receive points (TRPs) that are spaced apart from the AN 220.

The interfaces 213, 223 can each include one or more transmitter (TX) chains and one or more receiver (RX) chains. For instance, such RX chains can include low noise amplifiers, analogue to digital converters, mixers, etc. Analogue and/or digital beamforming would be possible.

Thereby, phase-coherent transmitting and/or receiving (communicating) can be implemented across the multiple antennas 214, 224. Thereby, the AN 220 and the UE 210 can selectively transmit on multiple TX beams (beamforming), to thereby direct energy into distinct spatial directions.

By using a TX beam, the direction of the wavefront of signals transmitted by a transmitter of the communication system is controlled. Energy is focused into a respective direction or even multiple directions, by phase-coherent superposition of the individual signals originating from each antenna 214, 224. Energy may also be focused to a specific point (or limited volume) at a specific direction and a specific distance of the transmitter. Thereby, a data stream may be directed in multiple spatial directions and/or to multiple specific points. The data streams transmitted on multiple beams can be independent, resulting in spatial multiplexing multi-antenna transmission; or dependent on each other, e.g., redundant, resulting in diversity multi-input multi-output (MIMO) transmission.

As a general rule, alternatively or additionally to such TX beams, it is possible to employ receive (RX) beams.

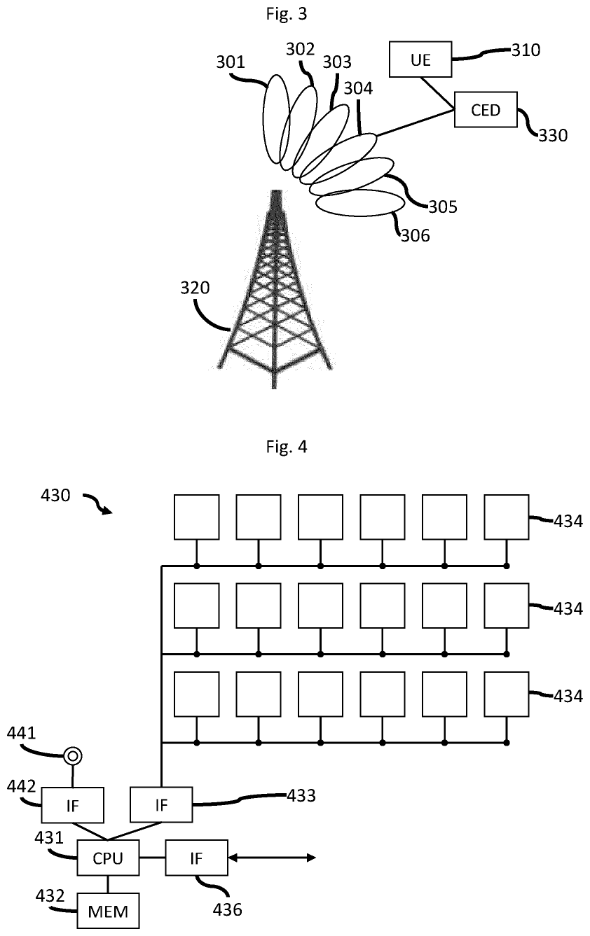

FIG. 3 illustrates DL TX beams 301-306 used by the AN 320. Here, the AN 320 activates the beams 301-306 on different resources (e.g., different time-frequency resources, and/or using orthogonal codes/precoding) such that the UE 310 can monitor for respective signals transmitted on the DL TX beams 301-306.

It is possible that the AN 320 transmits signals to the UE 310 via a CED 330. In the scenario of FIG. 3, the downlink transmit beam 304 is directed towards the CED 330. Thus, whenever the AN 320 transmits signals to the UE 310 using the downlink transmit beam 304—e.g., a respective block of a burst transmission-, a spatial filter is provided by the CED 330. The spatial filter is associated with a respective spatial direction into which the incident signals are then selectively reflected by the CED 330. Details with respect to the CED 330 are illustrated in connection with FIG. 4. FIG. 4 illustrates aspects in connection with the CED 430. The CED 430 includes a phased array of antennas 434 that impose a configurable phase shift when reflecting incident signals. This defines respective spatial filters that may be associated with spatial directions into which the incident signals are reflected. The antennas 434 can be passive or semi-passive elements. The CED 430 thus provides coverage extension by reflection of radio-frequency (RF) signals. A translation to the baseband may not be required. This is different to, e.g., decode-and-forward repeaters or regenerative functionality. The antennas 434 may induce an amplitude shift by attenuation. In some examples, the antennas 434 may provide forward amplification with or without translation of signals transmitted on the radio channel to the baseband. In some examples, the CEDs may be configurable to shift power from one polarization to the orthogonal polarization. The antennas 434 may amplify and forward the signals.

The CED 430 includes an antenna interface 433, which controls an array of antennas 434; a processor 431 can activate respective spatial filters one after another. The CED 430 further includes an interface 436 for receiving and/or transmitting signals on an auxiliary radio channel. The interface 436 may be a wireless interface. In some examples, the auxiliary radio channel may be replaced with a wired auxiliary channel and the interface 436 may be a wired interface. There is a memory 432 and the processor 431 can load program code from the non-volatile memory and execute the program code. Executing the program code causes the processor to perform techniques as described herein.

FIG. 4 is only one example implementation of a CED. Other implementations are conceivable. For example, a meta-material surface not including distinct antenna elements may be used. The meta-material can have a configurable refraction index. To provide a reconfigurable refraction index, the meta-material may be made of repetitive tunable structures that have extensions smaller than the wavelength of the incident RF signals.

### Communicating Via CEDs Using Different Beamwidths

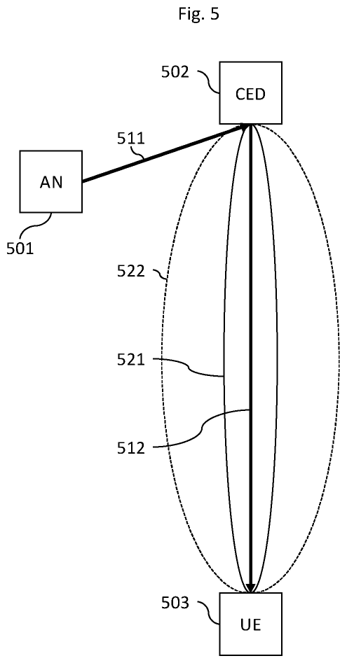

FIG. 5 illustrates a scenario in which an AN 501 is to communicate with a UE 503 on a radio channel via a CED 502. The CED 502 may receive, from the AN 501, an incident signal along the spatial direction 511 and transmit the incident signal, to the UE 503. Heretofore, a narrow beamwidth 521 or a wide beamwidth 522 may be used in the output direction. In some implementations of a CED, the beamwidth of the input and the output direction may be coupled.

As described hereinbefore, various approaches may be considered when deploying CEDs. The CED may be a reconfigurable relaying device, in particular a reconfigurable reflective or transmissive active intelligent surface. However, the CED may also be a network controlled smart repeater. An active CED may refer to a repeater node which has the capability to apply a power gain to an incident signal before transmitting the incident signal in the output spatial direction. A passive CED may denote a CED free of an active amplifier but capable of changing an EIRP level towards a given direction by changing the beamwidth/antenna array gain.

During beam-management it may be advantageous to use wider beams. Wider beams may be useful during UE beam identification and/or to support scenarios with high mobility. A beam-sweep using wider beams may allow for covering an area faster and may therefore achieve a lower latency. Various beamwidths may be used in a hierarchal way in multiple steps to narrow down to the most narrow beam. The most-narrow beam, which may be called a pencil beam, is typically the beam offering the largest antenna array gain. For wider beams, the antenna array gain may be lower.

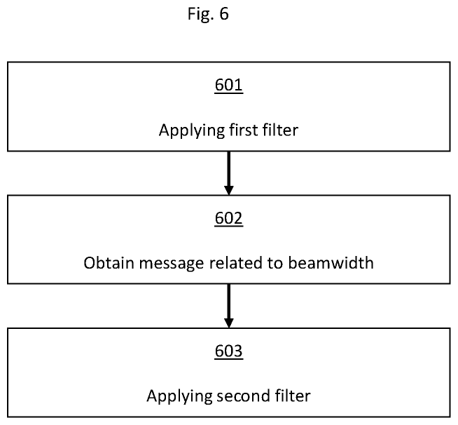

Thus, examples provide a method of operating a coverage enhancing device as illustrated with respect to FIG. 6. The CED provides reconfigurable filters for incident signals received along one or more input spatial directions on a radio channel and transmitted as outgoing signals into one or more output spatial directions.

As indicated with box 601, the method prescribes applying a first filter of the reconfigurable filters to receive an incident signal along one or more spatial directions on a radio channel and transmitting the incident signal as an outgoing signal into the output spatial direction.

Further, the method prescribes obtaining a message related to a beamwidth to be used for transmitting the incident signal as the outgoing signal into the output spatial direction (box 602).

Based on the message related to the beamwidth, the method prescribes applying a second filter of the reconfigurable filters to receive an incident signal along the one or more spatial directions on the radio channel and transmit the incident signal into the output spatial direction (box 603).

Further examples provide a method of operating an operator node (ON), wherein the operator node is configured for controlling a CED, wherein the CED provides reconfigurable filters for incident signals received along one or more input spatial directions on a radio channel and transmitted as outgoing signals into one or more output spatial directions.

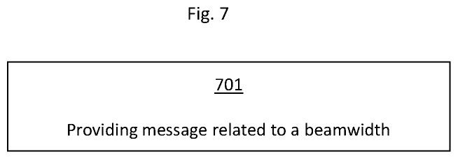

The method prescribes providing (box 701), to the CED, a message related to a beamwidth to be used for transmitting an incident signal as outgoing signal into an output spatial direction of the one or more output spatial directions (cf. FIG. 7).

In examples, the ON may be implemented by an AN communicating on a radio channel with a UE via the CED. In other examples, the ON may be implemented by the UE. Still further examples may prescribe that the ON is not involved in communicating via the CED.

In some scenarios, the message related to the beamwidth may be indicative of the beamwidth to be used for the transmission of the outgoing signal into the output spatial direction. For example, the message related to the beamwidth may directly indicate the beamwidth to be used. In another example, the message related to the beamwidth may indicate the filter to be used.

Other scenarios may prescribe that the message related to the beamwidth to be used for transmitting the incident signal as outgoing signal into the output spatial direction is indicative of an EIRP of the outgoing signal into the output spatial direction. Thus, the message related to the beamwidth may indirectly provide information on the beamwidth to be used. The message related to the beamwidth to be used for transmitting the incident signal as outgoing signal into the output spatial direction may be indicative of a relative EIRP or an absolute EIRP. Specifying a relative EIRP may be advantageous, if the CED is not aware of the power received from the input spatial direction. In some examples, the message related to the EIRP prescribes maintaining the EIRP.

Some scenarios may prescribe that the CED obtains a message indicative of a prescribed total radiated power (TRP). The TRP may be specified as an absolute or relative TRP.

In a scenario, a CED may be configured to transmit the outgoing signal in the output spatial direction using a beamwidth w and a radiation power level P. If a beamwidth 2w is desired, but the same radiation power level is to be maintained in the output spatial direction, the CED would ideally be reconfigured using a beamwidth 2w and a radiation power 2P. As the beamwidth is twice as large, the radiated power across the beam is, nominally, halved and, therefore the radiation power has to be doubled as well.

Some scenarios prescribe providing, by the CED, a message indicative of the reconfigurable filters. Thus, the ON may be informed about the CED capabilities. The message indicative of the reconfigurable filters may be indicative of a beamwidth and its associated EIRP.

However, in practice, the radiated power across the beam directions would not be maintained if the CED were to be configured with a beamwidth 2w and a radiation power level 2P. Configuring a CED such that it supports wide beam is very challenging. Further, how well wide beams may be configured depends strongly on the hardware implementation of the CED. As a consequence, configuring a CED to use a beam with a beamwidth 2w and a power level 2P may result in a twice as wide beam compared to a beam having a beamwidth w and a power level P, but the power across the beam may be spectacularly different. In theory, an inversely linear relation between beamwidth and power level (i.e., gain ratio) should hold, but in practice the relation may substantially differ.

The ON being made aware of the reconfigurable filters supported by the CED, in particular of the available beamwidths and its associated EIRPs, may take into account said information when deciding on the EIRP and/or beamwidths to be used by the CED. Thus, the ON may be able to control transmission power at the CED.

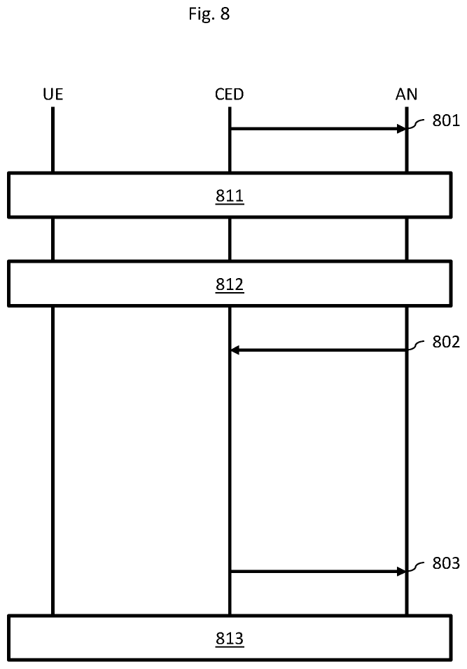

FIG. 8 is an exemplary signaling diagram illustrating a method of operating a CED and an ON. In the example of FIG. 8, the ON is implemented as an AN. The CED may not actively compensate for gain-loss (lower EIRP) induced by the use of a wider beam, e.g. the CED may be a passive CED.

The CED provides (and the ON obtains) a message 801 indicative of the reconfigurable filters provided by the CED. The message may be indicative of beamwidths and associated EIRPs. Thus, the CED may share its beam properties with the AN. The message 801 may be a dedicated messages requested by the AN. The message 801 may also be a default capability message. In some examples, the reconfigurable filters (i.e., the beam properties) may be further specified and the CED may report a classification associated with the reconfigurable filters (i.e., beam properties). The message 801 may include information on the beam configurations supported by the CED comprising at least one of a number of pencil beams, a number of refinement levels, a relative beamwidth and an associated gain, a polarization (i.e., if polarization can be independently controlled for the respective beam configuration) and/or if beam splitting is supported.

Thereafter, the UE and the AN may communicate on the radio channel via the CED as indicated with box 811 using a first filter of the reconfigurable filters associated with a certain beamwidth for transmitting an incident signal as an outgoing signal into an output spatial direction.

An event may trigger a changing at least one of the beamwidths as indicated with box 812. For example, an interference report may trigger changing a beamwidth of an outgoing signal.

The CED may obtain (and the ON provide) a message 802 related to a beamwidth to be used for transmitting the incident signal as the outgoing signal into the output spatial direction.

For example due to regulatory requirements, the CED may not be able to apply a filter complying with the massage 802. For example, applying a certain beamwidth may not be allowed under a given TRP level as the EIRP would exceed regulatory limitations.

Thus, examples prescribe that the CED provides (and the ON obtains) a message 803 indicative of a capability of the CED to comply with the message 802 related to the bandwidth. Hence, an (not) acknowledge ((n)ack) step may be added to ensure that the CED will not exceed the regulatory limitation.

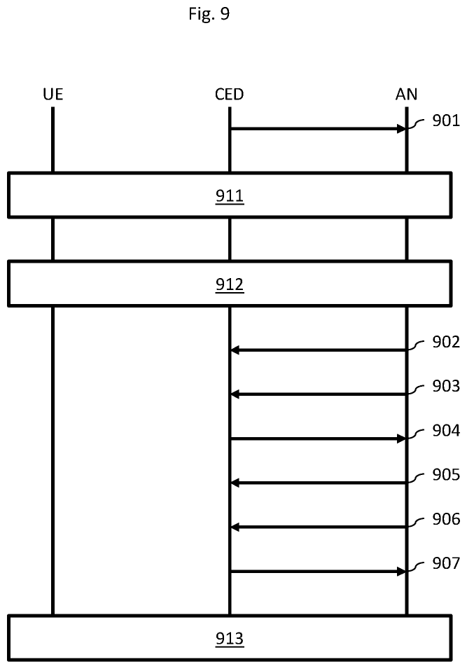

FIG. 9 is an exemplary signaling diagram illustrating a method of operating a CED and an ON. In the example of FIG. 9, the ON is again implemented as an AN. FIG. 9 may illustrate a method in which changes in the (observed or to be applied) gain are dynamically signaled between the CED and the ON. This approach may be advantageously needed if the ON is not aware of an actual gain setting, e.g., if only a relative gain is controlled by the ON.

As shown in FIG. 9, the CED may provide (and the ON obtain) a message 901 indicative of the reconfigurable filters provided by the CED. The message may be indicative of beamwidths and associated EIRPs. Thus, the CED may share its beam properties with the AN. The message 901 may be a dedicated messages requested by the AN. The message 901 may also be a default capability message. In some examples, the reconfigurable filters (i.e., the beam properties) may be further specified and the CED may report a classification associated with the reconfigurable filters (i.e., beam properties). The message 901 may be particularly indicative of the CED being able to maintain an EIRP upon changes of the TRP.

Afterwards, communication between the UE and the AN on the radio channel via the CED may take place as indicated with box 911 using a first filter of the reconfigurable filters associated with a certain beamwidth for transmitting an incident signal as an outgoing signal into an output spatial direction.

An event may trigger a changing at least one of the beamwidths as indicated with box 912. For example, an interference report may trigger changing a beamwidth of an outgoing signal.

The ON may provide (and the CED obtain) a message 902 related to a beamwidth to be used for transmitting the incident signal as the outgoing signal into the output spatial direction. The message 902 may be indirectly related to the beamwidth. As an example, the message 902 provided by the AN may indicate that the CED is to maintain a constant EIRP and the beamwidth may be controlled indirectly by a power control command adjusting the TRP level of the CED. A separate message 903 may be used for indicating the TRP level. This may allow for using established power control commands, e.g. power control commands specified in 3GPP, in particular 3GPP TS 38.213. However, the TRP level may also be indicated with the message 902.

The CED may try to actively keep the EIRP constant, independent of beamwidth configuration, but may fail when the maximum gain setting is reached. Then the CED may provide a message 904 indicative of the CED no longer being able to comply with the prescribed TRP and/or EIRP and/or bandwidth. The CED may then obtain a message 905 indicative of a new EIRP to be maintained by the CED and/or a message 906 indicative of a new TRP to be observed. After the reception of message 905 or 906, the CED may acknowledge with message 907 that it is able to comply with the required EIRP and/or TRP and communication 913 on the radio channel via the CED between the UE and the AN may be performed.

Enabling the use of various beamwidths at the CED and simultaneously enabling an ON to be aware of the obtained gain within a beam (more correctly the EIRP or power density within the beam at a certain distance) may offer substantial advantages for the communication between communication nodes via a CED.

Accordingly, an overhead for controlling the CED may be substantially reduced. Summarizing, at least the following EXAMPLES have been described above:
EXAMPLE 1. A method of operating a coverage enhancing device, CED, wherein the CED provides reconfigurable filters for incident signals received along one or more input spatial directions on a radio channel and transmitted as outgoing signals into one or more output spatial directions, the method comprising:
   applying (601) a first filter of the reconfigurable filters to receive an incident signal along one or more spatial directions on a radio channel and transmitting the incident signal as an outgoing signal into an output spatial direction,
   obtaining (602) a message related to a beamwidth to be used for transmitting the incident signal as the outgoing signal into the output spatial direction,
   applying (603) a second filter of the reconfigurable filters to receive an incident signal along the one or more spatial directions on the radio channel and transmit the incident signal as the outgoing signal into the output spatial direction using the beamwidth based on the message related to the beamwidth.
EXAMPLE 2. The method of operating the CED of EXAMPLE 1,
wherein the message related to a beamwidth to be used for transmitting the incident signal as outgoing signal into the output spatial direction is indicative of the beamwidth to be used for the transmission of the outgoing signal into the output spatial direction.
EXAMPLE 3. The method of operating the CED of EXAMPLE 1 or 2,
wherein the message related to the beamwidth to be used for transmitting the incident signal as outgoing signal into the output spatial direction is indicative of an equivalent isotropically radiated power, EIRP, of the outgoing signal into the output spatial direction.
EXAMPLE 4. The method of operating the CED of EXAMPLE 3,
wherein the message related to the beamwidth is indicative of a relative EIRP or an absolute EIRP.
EXAMPLE 5. The method of operating the CED of EXAMPLE 3,
wherein the message related to the EIRP prescribes maintaining the EIRP.
EXAMPLE 6. The method of operating the CED of any one of EXAMPLEs 1 to 5, further comprising
   obtaining a message indicative of a prescribed total radiated power, TRP.
EXAMPLE 7. The method of operating the CED of EXAMPLE 6,
wherein the TRP is an absolute or a relative TRP.
EXAMPLE 8. The method of operating the CED of any one of EXAMPLEs 1 to 7, further comprising
   providing a message indicative of a capability of the CED to comply with the message related to the bandwidth.
EXAMPLE 9. The method of operating the CED of any one of EXAMPLEs 1 to 8, further comprising
   providing a message indicative of the reconfigurable filters.
EXAMPLE 10. The method of operating the CED of EXAMPLE 9,
   wherein the message indicative of the reconfigurable filters is indicative of a beamwidth and its associated EIRP.
EXAMPLE 11. The method of operating the CED of any one of EXAMPLEs 1 to 10,
wherein applying the second filter comprises amplifying the incident signal.
EXAMPLE 12.A method of operating an operator node, ON, wherein the operator node is
configured for controlling a coverage enhancing device, CED, wherein the CED provides reconfigurable filters for incident signals received along one or more input spatial directions on a radio channel and transmitted as outgoing signals into one or more output spatial directions, the method comprising:
   providing (701), to the CED, a message related to a beamwidth to be used for transmitting an incident signal as outgoing signal into an output spatial direction of the one or more output spatial directions.
EXAMPLE 13. The method of operating the ON of EXAMPLE 12,
wherein the message related to the beamwidth is indicative of the beamwidth to be used for the transmission of the outgoing signal into the output spatial direction.
EXAMPLE 14. The method of operating the ON of EXAMPLE 12 or 13,
wherein the message related to the beamwidth to be used for transmitting the incident signal as the outgoing signal into the output spatial direction is indicative of an equivalent isotropically radiated power, EIRP, of the outgoing signal into the output spatial direction.
EXAMPLE 15. The method of operating the ON of EXAMPLE 14,
wherein the message related to the beamwidth is indicative of a relative EIRP or an absolute EIRP.
EXAMPLE 16. The method of operating the ON of any one of EXAMPLEs 12 to 15, further comprising
   providing a message indicative of a prescribed total radiated power, TRP.
EXAMPLE 17. The method of operating the ON of EXAMPLE 16,
wherein the TRP is an absolute or a relative TRP.
EXAMPLE 18. The method of operating the CED of EXAMPLE 16 or 17, further comprising
   obtaining a message indicative of capability of the CED to comply with the message related to the ERIP and the TRP.
EXAMPLE 19. The method of operating the CED of any one of EXAMPLEs 12 to 18, further comprising
   obtaining a message indicative of the reconfigurable filters.
EXAMPLE 20. The method of operating the CED of EXAMPLE 19,
   wherein the message indicative of the reconfigurable filters is indicative of a beamwidth and its associated EIRP.
EXAMPLE 21. The method of operating the CED of any one of EXAMPLES 1 to 18,
wherein applying the second filter comprises amplifying the incident signal.
EXAMPLE 22.A coverage enhancing device, CED,
wherein the CED provides reconfigurable filters for incident signals received along one or more input spatial directions on a radio channel and transmitted as outgoing signals into one or more output spatial directions,
the coverage enhancing device comprising control circuitry configured for performing the method of any one of EXAMPLEs 1 to 11.
EXAMPLE 23.An operator node, ON,
the operator node comprising control circuitry for controlling a coverage enhancing device, CED,
wherein the CED provides reconfigurable filters for incident signals received along one or more input spatial directions on a radio channel and transmitted as outgoing signals into one or more output spatial directions,
wherein the control circuitry is configured for performing the method of any one of EXAMPLEs 12 to 21.

1. A method of operating a coverage enhancing device (CED) wherein the CED provides reconfigurable filters for incident signals received along one or more input spatial directions on a radio channel and transmitted as outgoing signals into one or more output spatial directions, the method comprising:
applying a first filter of the reconfigurable filters to receive an incident signal along one or more spatial directions on a radio channel and transmitting the incident signal as an outgoing signal into an output spatial direction,
obtaining a message related to a beamwidth to be used for transmitting the incident signal as the outgoing signal into the output spatial direction, applying a second filter of the reconfigurable filters to receive an incident signal along the one or more spatial directions on the radio channel and transmit the incident signal as the outgoing signal into the output spatial direction using the beamwidth based on the message related to the beamwidth.

2. The method of operating the CED of claim 1, wherein the message related to a beamwidth to be used for transmitting the incident signal as outgoing signal into the output spatial direction is indicative of the beamwidth to be used for the transmission of the outgoing signal into the output spatial direction.

3. The method of operating the CED of claim 1, wherein the message related to the beamwidth to be used for transmitting the incident signal as outgoing signal into the output spatial direction is indicative of an equivalent isotropically radiated power (EIRP), of the outgoing signal into the output spatial direction.

4. The method of operating the CED of claim 3, wherein the message related to the beamwidth is indicative of a relative EIRP or an absolute EIRP.

5. The method of operating the CED of claim 3, wherein the message related to the EIRP prescribes maintaining the EIRP.

6. The method of operating the CED of claim 1, further comprising obtaining a message indicative of a prescribed total radiated power (TRP), TRP.

7. The method of operating the CED of claim 6, wherein the TRP is an absolute or a relative TRP.

8. The method of operating the CED of claim 1, further comprising providing a message indicative of a capability of the CED to comply with the message related to the bandwidth.

9. The method of operating the CED of claim 1, further comprising providing a message indicative of the reconfigurable filters.

10. The method of operating the CED of claim 9, wherein the message indicative of the reconfigurable filters is indicative of a beamwidth and its associated EIRP.

11. The method of operating the CED of claim 1, wherein applying the second filter comprises amplifying the incident signal.

12. A method of operating an operator node (ON), wherein the operator node is configured for controlling a coverage enhancing device (CED) wherein the CED provides reconfigurable filters for incident signals received along one or more input spatial directions on a radio channel and transmitted as outgoing signals into one or more output spatial directions, the method comprising:
providing to the CED, a message related to a beamwidth to be used for transmitting an incident signal as outgoing signal into an output spatial direction of the one or more output spatial directions.

13. The method of operating the ON of claim 12, wherein the message related to the beamwidth is indicative of the beamwidth to be used for the transmission of the outgoing signal into the output spatial direction.

14. The method of operating the ON of claim 12, wherein the message related to the beamwidth to be used for transmitting the incident signal as the outgoing signal into the output spatial direction is indicative of an equivalent isotropically radiated power, EIRP, of the outgoing signal into the output spatial direction.

15. The method of operating the ON of claim 14, wherein the message related to the beamwidth is indicative of a relative EIRP or an absolute EIRP.

16. The method of operating the ON of claim 12, further comprising providing a message indicative of a prescribed total radiated power (TRP).

17. The method of operating the ON of claim 16, wherein the TRP is an absolute or a relative TRP.

18. The method of operating the CED of claim 16, further comprising obtaining a message indicative of capability of the CED to comply with the message related to the ERIP and the TRP.

19. The method of operating the CED of claim 12, further comprising obtaining a message indicative of the reconfigurable filters.

20. The method of operating the CED of claim 19, wherein the message indicative of the reconfigurable filters is indicative of a beamwidth and its associated EIRP.

21-23. (canceled)
